(19) United States
(12) Patent Application Publication
(10) Pub. No.: US 2024/0095556 A1
(43) Pub. Date: Mar. 21, 2024

(54) Automated Detection and Extraction of Interacting Variables for Predictive Models

(71) Applicant: STATE FARM MUTUAL AUTOMOBILE INSURANCE COMPANY, Bloomington, IL (US)

(72) Inventor: Forrestt Severtson, Alpharetta, GA (US)

(21) Appl. No.: 18/240,177

(22) Filed: Aug. 30, 2023

Related U.S. Application Data
(60) Provisional application No. 63/408,301, filed on Sep. 20, 2022.

(51) Int. Cl. G06N 7/00

(52) U.S. Cl. CPC G06N 7/00

(57) ABSTRACT

Techniques for detecting interactions between predictor variables in a statistical model are provided. The techniques include identifying predictor variables for a dependent variable; and for each pair of predictor variables: obtaining a dataset including (i) first predictor variable values, (ii) second predictor variable values, and (iii) dependent variable values associated with each pair of a first predictor variable value and a second predictor variable value; generating a three-dimensional graph based on the dataset, wherein each point of the three-dimensional graph includes a first coordinate value associated with a first predictor variable, a second coordinate value associated with a second predictor variable, and a third coordinate value associated with a dependent variable outcome; and analyzing the three-dimensional graph to determine a measure of spatial randomness associated with the three-dimensional graph. The techniques further include identifying pairs of predictor variables having interactions based on their respective measures of spatial randomness.

### CROSS-REFERENCE TO RELATED APPLICATION

The present application claims priority to U.S. Provisional Application No. 63/408,301, filed Sep. 20, 2022 and entitled “Automated Detection and Extraction of Interacting Variables for Predictive Models,” the entirety of which is incorporated by reference herein.

### FIELD OF THE DISCLOSURE

The present disclosure generally relates to technologies associated with statistical modeling and, more particularly, to technologies for detecting interactions between predictor variables in a statistical model.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Building a strong predictive model requires an understanding of the interactions between predictor variables. Conventionally, an individual working on the predictive model will manually examine pairs of predictor variables that they believe to be likely to have interactions based on an intuitive understanding of a modeling data set. However, this means that pairs of predictor variables that may be assumed to be unlikely to have interactions (i.e., pairs of predictor variables that have interactions that are not intuitive) may never be examined, because manually examining all possible pairs of variables is infeasible in a predictive model that includes a large number of predictor variables. Consequently, predictive models that include a large number of predictor variables may be limited by the assumptions of the individuals who create the predictive models.

### SUMMARY

The present disclosure provides techniques for automatically evaluating all possible pairs of predictor variables. Using statistical tests for complete spatial randomness, each pair is evaluated as to the likelihood of an interaction being present. Those pairs exceeding a predetermined cutoff are then automatically examined for interactions such as clustering or standard morphologies. When an interaction is found it is automatically encoded into a Boolean function indicating the presence of the interaction. This function is then applied to the data set thereby providing additional predictor variables.

These techniques enable a modeler to evaluate all possible pairs of interacting variables, something that is not currently done. Once interactions are found, they can be encoded into additional predictive features which will improve the performance of the model. These techniques allow for the faster development of stronger predictive models than current practices.

In one aspect, a computer-implemented method for detecting interactions between predictor variables in a statistical model is provided. The method includes: identifying, by one or more processors, a plurality of predictor variables for a dependent variable; for each pair of predictor variables, of the plurality of predictor variables: obtaining, by the one or more processors, a dataset including (i) first predictor variable values, (ii) second predictor variable values, and (iii) dependent variable values associated with each pair of a first predictor variable value and a second predictor variable value; generating, by the one or more processors, a three-dimensional graph based on the dataset, wherein each point of the three-dimensional graph includes a first coordinate value associated with a first predictor variable, a second coordinate value associated with a second predictor variable, and a third coordinate value associated with a dependent variable outcome; and analyzing, by the one or more processors, the three-dimensional graph to determine a measure of spatial randomness associated with the three-dimensional graph; and identifying, by the one or more processors, one or more pairs of predictor variables having interactions based on their respective measures of spatial randomness.

In another aspect, a system for detecting interactions between predictor variables in a statistical model is provided. The system includes: one or more processors; and a memory storing computer-readable instructions that, when executed by the one or more processors, cause the one or more processors to: identify a plurality of predictor variables for a dependent variable; for each pair of predictor variables, of the plurality of predictor variables: obtain a dataset including (i) first predictor variable values, (ii) second predictor variable values, and (iii) dependent variable values associated with each pair of a first predictor variable value and a second predictor variable value; generate a three-dimensional graph based on the dataset, wherein each point of the three-dimensional graph includes a first coordinate value associated with a first predictor variable, a second coordinate value associated with a second predictor variable, and a third coordinate value associated with a dependent variable outcome; and analyze the three-dimensional graph to determine a measure of spatial randomness associated with the three-dimensional graph; and identify one or more pairs of predictor variables having interactions based on their respective measures of spatial randomness.

In still another aspect, a computer-readable medium storing non-transitory instructions for detecting interactions between predictor variables in a statistical model is provided. The instructions, when executed by one or more processors, cause the one or more processors to: identify a plurality of predictor variables for a dependent variable; for each pair of predictor variables, of the plurality of predictor variables: obtain a dataset including (i) first predictor variable values, (ii) second predictor variable values, and (iii) dependent variable values associated with each pair of a first predictor variable value and a second predictor variable value; generate a three-dimensional graph based on the dataset, wherein each point of the three-dimensional graph includes a first coordinate value associated with a first predictor variable, a second coordinate value associated with a second predictor variable, and a third coordinate value associated with a dependent variable outcome; and analyze the three-dimensional graph to determine a measure of spatial randomness associated with the three-dimensional graph; and identify one or more pairs of predictor variables having interactions based on their respective measures of spatial randomness.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an exemplary computer system for detecting interactions between predictor variables in a statistical model, according to one embodiment;

FIG. 2A depicts an exemplary three-dimensional graph that may be generated from a dataset including predictor variable values for two predictor variables of a predictor variable pair and dependent variable values for the predictor variable pair, according to one embodiment;

FIG. 2B is a two-dimensional graph illustrating the same data as shown at FIG. 2A for binary dependent variable results, according to one embodiment;

FIG. 2C is a two-dimensional graph illustrating the same data as shown at FIG. 2A for non-binary dependent variable results, in the form of a heat map, according to one embodiment;

FIG. 2D illustrates an example of a transformation that may be applied to a two-dimensional and/or three-dimensional graph associated with a predictor variable pair, e.g., as shown at FIGS. 2A, 2B, and/or 2C, in order to identify lines associated with the predictor variable pair and in turn generate a function defining an interaction associated with the predictor variable pair, according to one embodiment;

FIG. 2E illustrates an example of a transformation that may be applied to a two-dimensional graph associated with a predictor variable pair, e.g., as shown at FIG. 2B or 2C, in order to identify blobs associated with the predictor variable pair and in turn generate a function or other relationship defining an interaction associated with the predictor variable pair, according to one embodiment;

FIG. 2F illustrates an example of a transformation that may be applied to a three-dimensional graph associated with a predictor variable pair, e.g., as shown at FIG. 2A, in order to identify a polygon associated with the predictor variable pair and in turn generate a function or other relationship defining an interaction associated with the predictor variable pair, according to one embodiment;

FIG. 3 depicts a flow diagram of an exemplary computer-implemented method for detecting interactions between predictor variables in a statistical model, according to one embodiment; and

FIG. 4 depicts an exemplary computing system in which the techniques described herein may be implemented, according to one embodiment.

While the systems and methods disclosed herein is susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples. Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

The present disclosure provides techniques for the automatic detection and extraction of pairs of interacting variables in a predictive model. In particular, the present disclosure provides techniques for rank ordering the pairs of predictor variables with respect to the likelihood of an interaction between the two variables being present. All pairs exceeding a specified cut off level will have the interacting features automatically extracted, and code is produced that indicates whether or not a pair of observed values of the two variables is present in the interaction. This code can then be executed to append a variable to the set of predictor variables indicating the presence of the interaction.

Generally speaking, a data set containing a dependent variable and possible predictor variables is presented to the process. All possible pairs of predictors are considered. Using the values of the predictor variables as coordinates in two dimensional space, the dependent variable defines an outcome located at those coordinates. This spatial pattern is then tested for complete spatial randomness and the resulting score is the score reported for this particular pair. The list of all possible pairs of variables are sorted by the reported score with the most high scoring ones being the most likely to have an interaction present. Using a predetermined cutoff score, set by the modeler, all pairs of variables are examined whose score exceeds the cutoff level. For each pair of variables being examined, various types of interactions are looked for. The most likely interaction pattern found then causes code to be generated that builds an indicator function for that particular interaction pattern found in the data. These interaction encodings are then sent to a script which, when executed, will append additional predictor variables to the dataset.

All possible pairs of interacting variables are automatically considered thereby greatly reducing the time required for a complete examination of interacting pairs. All possible pairs are rank ordered by the likelihood of having predictive interactions allowing the modeler to focus on a predetermined portion of the most likely interacting pairs. The most likely pairs are then automatically examined to determine the kind of interaction that is present. Code is automatically generated, based on the type of interaction identified, that will indicate the presence or absence of the interaction at given pairs of values of the interacting variables. This code can then be automatically executed to append additional variables to the list of possible predictor variables.

### Exemplary System for Detecting Interactions Between Predictor Variables in a Statistical Model

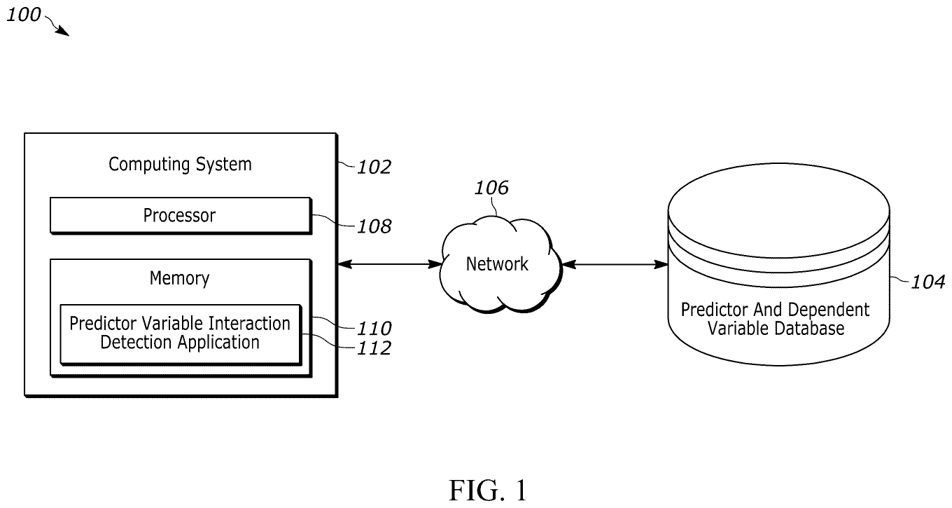

Referring now to the drawings, FIG. 1 depicts an exemplary system 100 for detecting interactions between predictor variables in a statistical model, according to one embodiment. The high-level architecture illustrated in FIG. 1 may include both hardware and software applications, as well as various data communications channels for communicating data between the various hardware and software components, as is described below.

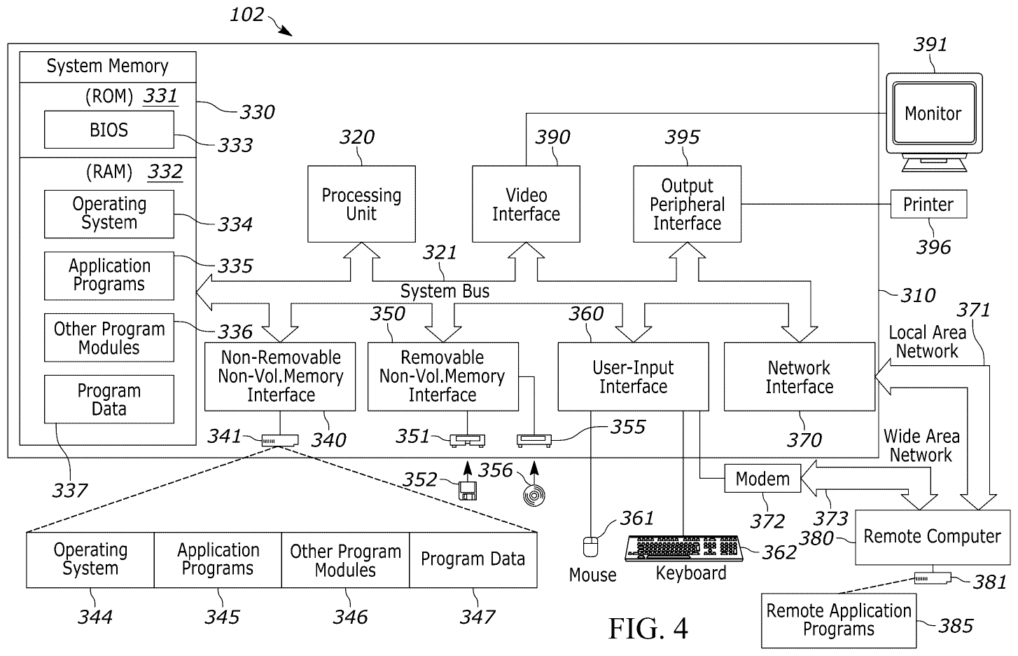

The system 100 may include a computing system 102, which is described in greater detail below with respect to FIG. 4, and one or more databases 104, e.g., configured to communicate with one another via a wired or wireless computer network 106. Although one computing system 102, one database 104, and one network 106 are shown in FIG. 1, any number of such computing systems 102, databases 104, and networks 106 may be included in various embodiments.

In some embodiments the computing system 102 may comprise one or more servers, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s) such as MICROSOFT AZURE, AMAZON AWS, or the like. Such server(s) may include one or more processor(s) 108 (e.g., CPUs) as well as one or more computer memories 110.

Memories 110 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 110 may store an operating system (OS) (e.g., Microsoft Windows, Linux, UNIX, etc.) capable of facilitating the functionalities, apps, methods, or other software as discussed herein. Memorie(s) 110 may also store a predictor variable interaction detection application 112. Additionally, or alternatively, the memorie(s) 110 may store a dataset including a plurality of predictor variables associated with a dependent variable, including predictor variable values and associated dependent variable values. This dataset may also be stored in a predictor and dependent variable database 104, which may be accessible or otherwise communicatively coupled to the computing system 102.

Executing the predictor variable interaction detection application 112 may include identifying a dependent variable and a plurality of predictor variables for the dependent variable (e.g., based on data retrieved from the database 104). Using the plurality of predictor variables, the predictor variable interaction detection application 112 may generate pairs of predictor variables, pairing each of the predictor variables with each other predictor variable until all possible pairs have been generated. In some examples, the predictor variable interaction detection application 112 may obtain the pairs of predictor variables from the database 104 rather than generating the pairs of predictor variables. In any case, each pair of predictor variables may include a first predictor variable and a second predictor variable, and for each pair of predictor variables, the predictor variable interaction detection application 112 may obtain or generate a dataset including first predictor variable values, second predictor variable values, and dependent variable values.

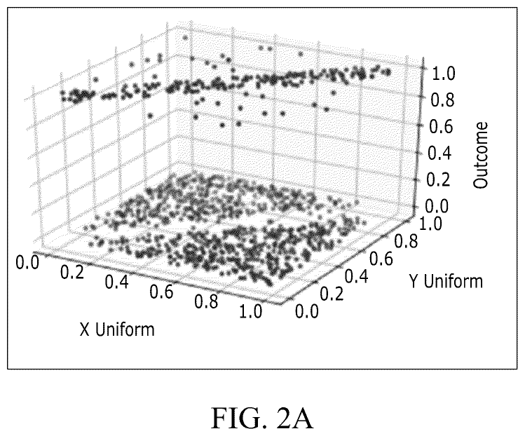

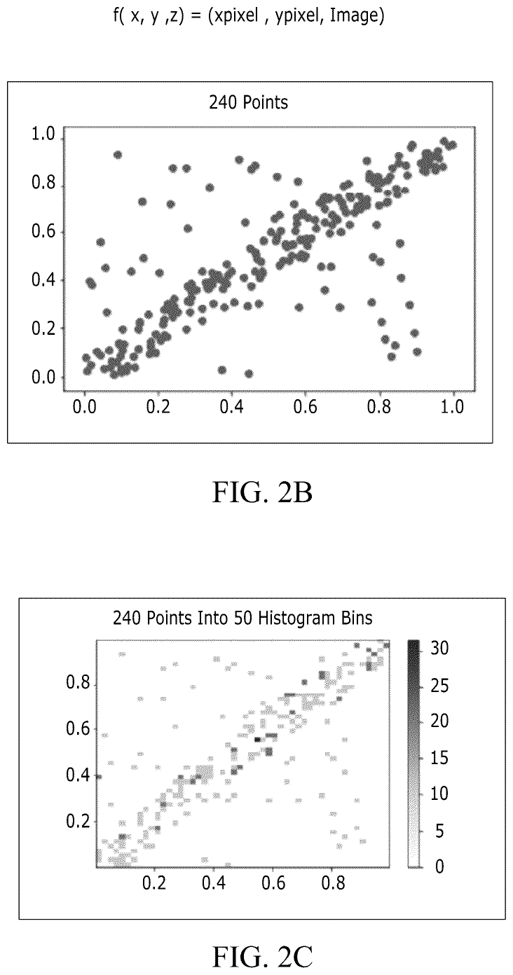

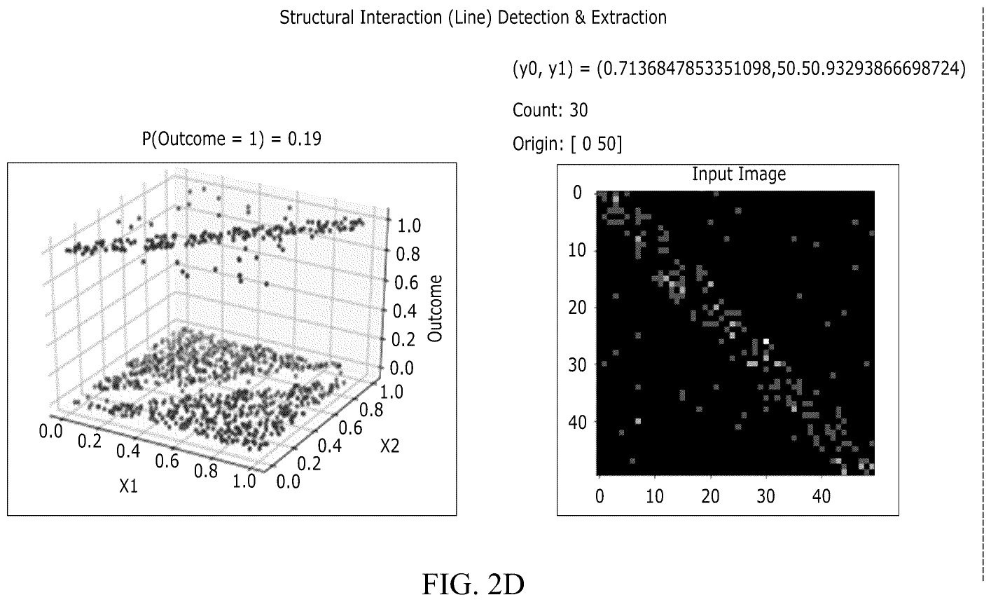

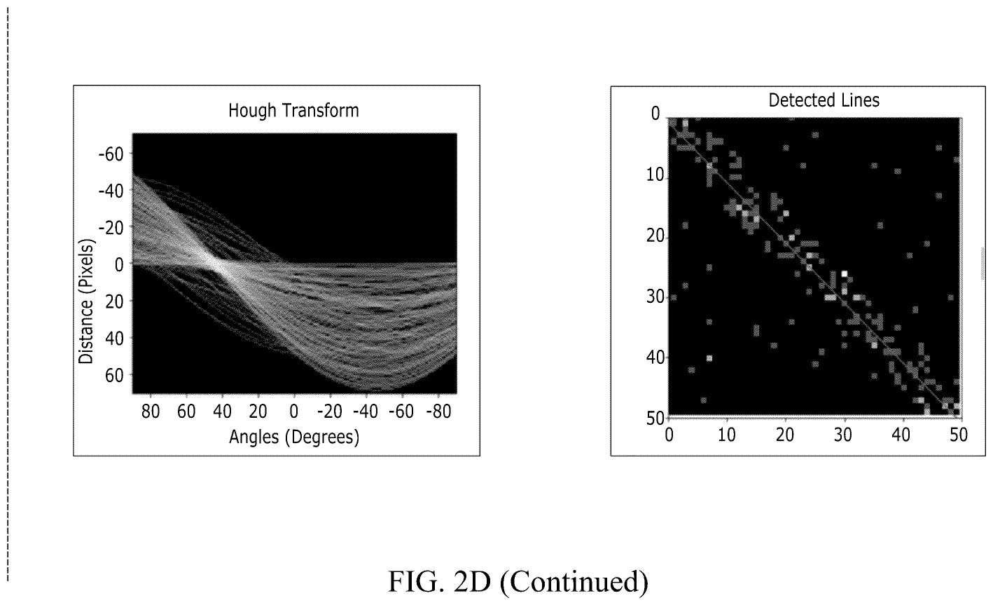

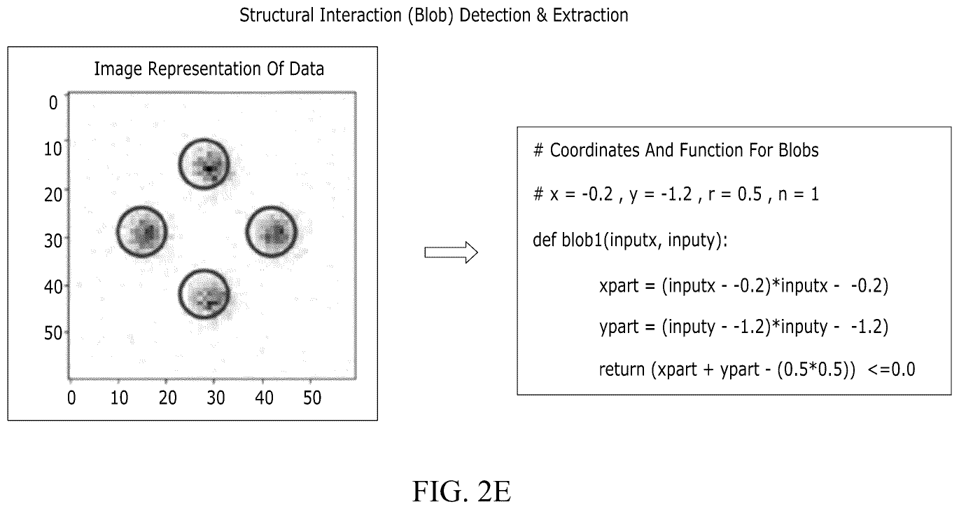

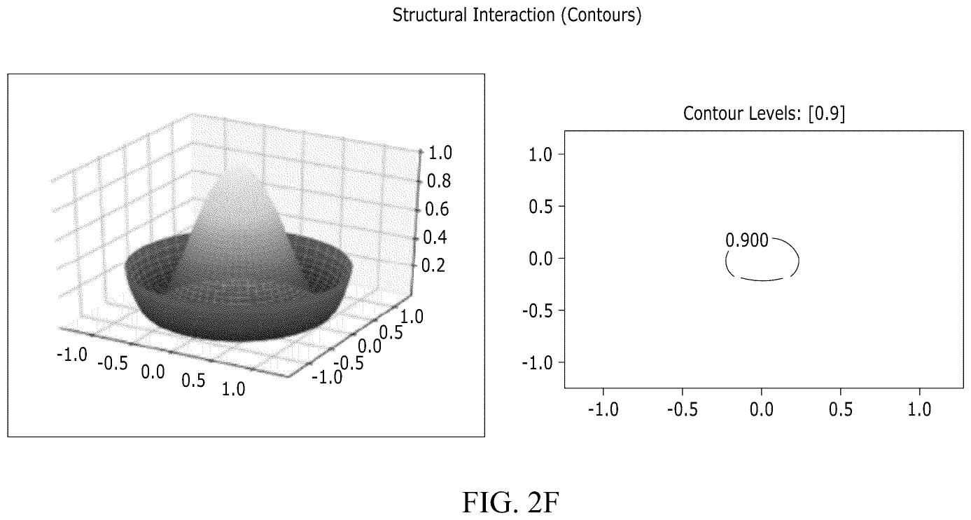

The predictor variable interaction detection application 112 may generate a three-dimensional graph based on the dataset. An example of such a three-dimensional graph is shown at FIG. 2A. Each point of the three-dimensional graph may include a first coordinate value associated with a first predictor variable (e.g., an x-coordinate value), a second coordinate value associated with a second predictor variable (e.g., a y-coordinate value), and a third coordinate value associated with a dependent variable outcome (e.g., a z-coordinate value). The number of points of the three-dimensional graph may be set by the predictor variable interaction detection application 112. For instance, the predictor variable interaction detection application 112 may generate 100 points, 200 points, 500 points, etc. based on a setting of the predictor variable detection application 112. The predictor variable detection application 112 may generate each point by generating a random value for the first predictor variable (e.g., within a range of values) and generating a random value for the second predictor variable (e.g., within a range of values), and determining a value for the dependent value, e.g., by retrieving a value for the dependent value from the database 104 when first predictor value is set as the first random value and the second predictor variable is set as the second random value. In some examples, e.g., as shown at FIG. 2A, the predictor variable detection application 112 may generate a binary value based on the determined dependent variable value. In some examples, the dependent variable value may be binary already (e.g., the dependent value is a “yes” or “no”), while in other examples, the dependent variable value may be reduced to a binary value based on a threshold or other calculation (e.g., a dependent value below 5 returns a “0”, while dependent value above 5 returns a “1”).

In some examples, the predictor variable interaction detection application 112 may, additionally or alternatively, generate a two-dimensional graph based on the dataset. For example, FIG. 2B is a two-dimensional graph illustrating the same data as shown at FIG. 2A for binary dependent variable results (i.e., such that dependent variable outcomes of “0” are not shown, while outcomes of “1” are shown). As another example, FIG. 2C is a two-dimensional graph illustrating the same data as shown at FIG. 2A for non-binary dependent variable results, in the form of a heat map (i.e., with higher dependent variable values shown darker, and lower dependent variable values shown lighter).

The predictor variable interaction detection application 112 may analyze the three-dimensional graph (e.g., as shown at FIG. 2A) in order to determine a measure of spatial randomness associated with the three-dimensional graph. In some examples, the predictor variable interaction detection application 112 may, additionally or alternatively, analyze a two-dimensional graph (e.g., as shown at FIG. 2B and/or FIG. 2C) in order to determine a measure of spatial randomness associated with the two-dimensional graph.

In some examples, the measure of spatial randomness of the three-dimensional graph or the two-dimensional graph may be a measurement of a likelihood of the points as shown in the three-dimensional graph or the two-dimensional graph being completely spatially random. That is, generally speaking, if there is an interaction between the two predictor variables, the three-dimensional graph or the two-dimensional graph will include some type of pattern (i.e., will not be close to being completely spatially random), but if there is no interaction between the two predictor variables, the three-dimensional graph or the two-dimensional graph will not include a pattern (i.e., will be close to being completely spatially random).

There are many possible ways to determine the likelihood of a pattern being completely spatially random, including Ripley's K function, or Minkowski functionals. As one example, the probability of finding exactly k points within the area V is event density ρ, therefore:

$$P ( k , ρ , V ) = \frac{{( V ρ )}^{k} {e}^{- ( V ρ )}}{k !}$$

The first moment of which, the average number of points in the area is simply ρV.

The predictor variable interaction detection application 112 may repeat this process for each of the possible pairs of predictor variables. Accordingly, the predictor variable interaction detection application 112 may identify one or more pairs of predictor variables that have interactions, from all of the possible pairs of predictor variables, based on each predictor variable pair's measure of spatial randomness. As discussed above, the predictor variable pairs that are least likely to be completely spatially random are the best candidates for an interaction being present.

For instance, the predictor variable interaction detection application 112 may identify a number of predictor variable pairs associated with measures of spatial randomness above a threshold value as being predictor variable pairs that have interactions or are likely to have interactions. As another example the predictor variable interaction detection application 112 may rank the spatial randomness associated with each of the predictor variable pairs and may identify a set number or a set percentage of the predictor variable pairs as having interactions or as likely having interactions based on their measures of spatial randomness.

In some examples, the predictor variable interaction detection application 112 may generate interaction functions (or other relationships) associated with the predictor variable pairs identified as having interactions or as being likely to have interactions. For instance, the predictor variable interaction detection application 112 may generate an interaction function (or other relationship) for a given predictor variable pair based on the relationship between the first predictor variable and second predictor variable of the predictor variable pair. In some examples, the predictor variable interaction detection application 112 may generate the interaction function or other relationship associated with a predictor variable pair by determining an interaction pattern associated with the predictor variable pair. For instance, possible interaction patterns may include an additive interaction patterns, an antagonistic interaction pattern, a synergistic interaction pattern, an atypical interaction pattern, etc.

In some examples, the predictor variable interaction detection application 112 may apply an automatic detection and extraction algorithm to the three-dimensional graphs or two-dimensional graphs associated with the predictor variable pairs identified as most likely to have interactions with one another in order to generate a function or other relationship between the two predictor variables of each predictor variable pair. For instance, the automatic detection and extraction algorithm may identify lines, blobs, contours, conics, ellipses, hyperbolas, edges, polygons or other shapes/elements present in the three-dimensional graphs or two-dimensional graphs associated with the predictor variable pairs identified as most likely to have interactions with one another. For example, FIG. 2D illustrates an example of a transformation that may be applied to a two-dimensional and/or three-dimensional graph associated with a predictor variable pair in order to identify a line associated with the predictor variable pair, and in turn generate a function defining an interaction associated with the predictor variable pair. As another example, FIG. 2E illustrates an example of a transformation that may be applied to a two-dimensional graph associated with a predictor variable pair in order to identify blobs associated with the predictor variable pair, and in turn generate a function or other relationship defining an interaction associated with the predictor variable pair. As still another example, FIG. 2F illustrates an example of a transformation that may be applied to a three-dimensional, non-binary graph associated with a predictor variable pair in order to identify a polygon associated with the predictor variable pair and in turn generate a function or other relationship defining an interaction associated with the predictor variable pair.

The predictor variable interaction detection application 112 may incorporate any functions or other relationships that are generated for various predictor variable pairs into a model in order to predict an outcome (i.e., dependent variable) of interest, materially improving the performance of that model.

In addition to the predictor variable interaction detection application 112, memories 110 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. It should be appreciated that one or more other applications may be envisioned and that are executed by the processor(s) 108. It should be appreciated that given the state of advancements of mobile computing devices, all of the processes functions and steps described herein may be present together on a mobile computing device (e.g., user computing device 104).

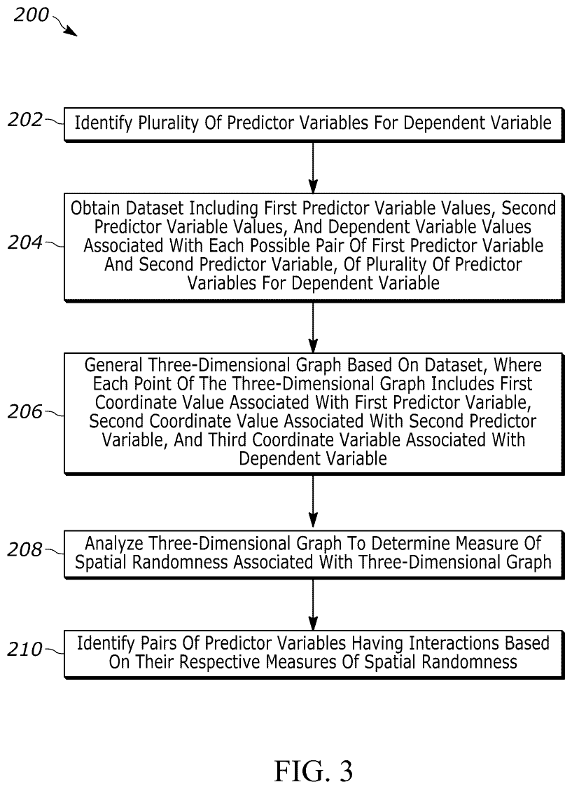

Furthermore, in some examples, the computer-readable instructions stored on the memory 110 may include instructions for carrying out any of the steps of the method 200 via an algorithm executing on the processors 108, which is described in greater detail below with respect to FIG. 3.

### Exemplary Computer-Implemented Method for Detecting Interactions Between Predictor Variables in a Statistical Model

FIG. 3 depicts a flow diagram of an exemplary computer-implemented method 200 for detecting interactions between predictor variables in a statistical model, according to one embodiment. One or more steps of the method 200 may be implemented as a set of instructions stored on a computer-readable memory (e.g., memory 110) and executable on one or more processors (e.g., processor 108).

A plurality of predictor variables for a dependent variable may be identified (block 202).

For each pair of predictor variables, of the plurality of predictor variables: a dataset including first predictor variable values, second predictor variable values, and dependent variable values associated with each pair of a first predictor variable value and a second predictor variable value may be obtained (block 204).

A three-dimensional graph may be generated (block 206) based on the dataset. Each point of the three-dimensional graph may include a first coordinate value associated with a first predictor variable, a second coordinate value associated with a second predictor variable, and a third coordinate value associated with a dependent variable outcome. For instance, the first coordinate value may be an x-coordinate value, the second coordinate value may be a y-coordinate value, and the third coordinate value may be a z-coordinate value.

The three-dimensional graph may be analyzed (block 208) to determine a measure of spatial randomness associated with the three-dimensional graph.

One or more pairs of predictor variables having interactions may be identified (block 210) based on their respective measures of spatial randomness. For instance, identifying the one or more pairs of predictor variables having interactions may be based on their respective measures of spatial randomness being greater than a threshold measure of spatial randomness.

In some examples, the method 200 may further include generating interaction functions associated with the respective one or more pairs of predictor variables having interactions. For instance, the interaction functions associated with the respective one or more pairs of predictor variables having interactions may be generated based on relationships between the first predictor variable and second predictor variable of each of the respective one or more predictor variable pairs. In some examples, generating the interaction functions associated with the respective one or more pairs of predictor variables having interactions may include determining interaction patterns associated with the respective one or more pairs of predictor variables having interactions. For instance, possible interaction patterns may include an additive interaction patterns, an antagonistic interaction pattern, a synergistic interaction pattern, an atypical interaction pattern, etc.

### Exemplary Computing System for Detecting Interactions Between Predictor Variables in a Statistical Model

FIG. 4 depicts an exemplary computing system 102 in which the techniques described herein may be implemented, according to one embodiment. The computing system 102 of FIG. 4 may include a computing device in the form of a computer 310. Components of the computer 310 may include, but are not limited to, a processing unit 320 (e.g., corresponding to the processor 108 of FIG. 1), a system memory 330 (e.g., corresponding to the memory 110 of FIG. 1), and a system bus 321 that couples various system components including the system memory 330 to the processing unit 320. The system bus 321 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 may include a variety of computer-readable media. Computer-readable media may be any available media that can be accessed by computer 310 and may include both volatile and nonvolatile media, and both removable and non-removable media. By way of example, and not limitation, computer-readable media may comprise computer storage media and communication media.

Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 330 may include computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to, and/or presently being operated on, by processing unit 320. By way of example, and not limitation, FIG. 4 illustrates operating system 334, application programs 335 (e.g., corresponding to the predictor variable interaction detection application 112 of FIG. 1), other program modules 336, and program data 337.

The computer 310 may also include other removable/non-removable, volatile/nonvolatile computer storage media. By way of example only, FIG. 4 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 may be connected to the system bus 321 through a non-removable memory interface such as interface 340, and magnetic disk drive 351 and optical disk drive 355 may be connected to the system bus 321 by a removable memory interface, such as interface 350.

The drives and their associated computer storage media discussed above and illustrated in FIG. 4 provide storage of computer-readable instructions, data structures, program modules and other data for the computer 310. In FIG. 4, for example, hard disk drive 341 is illustrated as storing operating system 344, application programs 345, other program modules 346, and program data 347. Note that these components may either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as cursor control device 361 (e.g., a mouse, trackball, touch pad, etc.) and keyboard 362. A monitor 391 or other type of display device is also connected to the system bus 321 via an interface, such as a video interface 390. In addition to the monitor, computers may also include other peripheral output devices such as printer 396, which may be connected through an output peripheral interface 395.

The computer 310 may operate in a networked environment using logical connections to one or more remote computers, such as a remote computer 380. The remote computer 380 may be a mobile computing device, personal computer, a server, a router, a network PC, a peer device or other common network node, and may include many or all of the elements described above relative to the computer 310, although only a memory storage device 381 has been illustrated in FIG. 4. The logical connections depicted in FIG. 4 include a local area network (LAN) 371 and a wide area network (WAN) 373 (e.g., either or both of which may correspond to the network 106 of FIG. 1), but may also include other networks. Such networking environments are commonplace in hospitals, offices, enterprise-wide computer networks, intranets and the Internet.

When used in a LAN networking environment, the computer 310 is connected to the LAN 371 through a network interface or adapter 370. When used in a WAN networking environment, the computer 310 may include a modem 372 or other means for establishing communications over the WAN 373, such as the Internet. The modem 372, which may be internal or external, may be connected to the system bus 321 via the input interface 360, or other appropriate mechanism. The communications connections 370, 372, which allow the device to communicate with other devices, are an example of communication media, as discussed above. In a networked environment, program modules depicted relative to the computer 310, or portions thereof, may be stored in the remote memory storage device 381. By way of example, and not limitation, FIG. 4 illustrates remote application programs 385 as residing on memory device 381.

The techniques for detecting interactions between predictor variables in a statistical model described above may be implemented in part or in their entirety within a computing system such as the computing system 102 illustrated in FIG. 4. In some such embodiments, the LAN 371 or the WAN 373 may be omitted. Application programs 335 and 345 may include a software application (e.g., a web-browser application) that is included in a user interface, for example.

### ADDITIONAL CONSIDERATIONS

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for detecting interactions between predictor variables in a statistical model. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for detecting interactions between predictor variables in a statistical model, the method comprising:
identifying, by one or more processors, a plurality of predictor variables for a dependent variable;
for each pair of predictor variables, of the plurality of predictor variables:
obtaining, by the one or more processors, a dataset including (i) first predictor variable values, (ii) second predictor variable values, and (iii) dependent variable values associated with each pair of a first predictor variable value and a second predictor variable value;
generating, by the one or more processors, a three-dimensional graph based on the dataset, wherein each point of the three-dimensional graph includes a first coordinate value associated with a first predictor variable, a second coordinate value associated with a second predictor variable, and a third coordinate value associated with a dependent variable outcome; and
analyzing, by the one or more processors, the three-dimensional graph to determine a measure of spatial randomness associated with the three-dimensional graph; and
identifying, by the one or more processors, one or more pairs of predictor variables having interactions based on their respective measures of spatial randomness.

2. The computer-implemented method of claim 1, wherein the first coordinate value is an x-coordinate value, the second coordinate value is a y-coordinate value, and the third coordinate value is a z-coordinate value.

3. The computer-implemented method of claim 1, wherein identifying the one or more pairs of predictor variables having interactions is based on their respective measures of spatial randomness being greater than a threshold measure of spatial randomness.

4. The computer-implemented method of claim 1, further comprising:
generating, by the one or more processors, interaction functions associated with the respective one or more pairs of predictor variables having interactions.

5. The computer-implemented method of claim 4, wherein the interaction functions associated with the respective one or more pairs of predictor variables having interactions are generated based on relationships between the first predictor variable and second predictor variable of the respective one or more predictor variable pairs.

6. The computer-implemented method of claim 4, wherein generating the interaction functions associated with the respective one or more pairs of predictor variables having interactions includes determining interaction patterns associated with the respective one or more pairs of predictor variables having interactions.

7. The computer-implemented method of claim 6, wherein the interaction patterns include one or more of additive interaction patterns, antagonistic interaction patterns, synergistic interaction patterns, and atypical interaction patterns.

8. A system for detecting interactions between predictor variables in a statistical model, the system comprising:
one or more processors; and
a memory storing computer-readable instructions that, when executed by the one or more processors, cause the one or more processors to:
identify a plurality of predictor variables for a dependent variable;
for each pair of predictor variables, of the plurality of predictor variables:
obtain a dataset including (i) first predictor variable values, (ii) second predictor variable values, and (iii) dependent variable values associated with each pair of a first predictor variable value and a second predictor variable value;
generate a three-dimensional graph based on the dataset, wherein each point of the three-dimensional graph includes a first coordinate value associated with a first predictor variable, a second coordinate value associated with a second predictor variable, and a third coordinate value associated with a dependent variable outcome; and
analyze the three-dimensional graph to determine a measure of spatial randomness associated with the three-dimensional graph; and
identify one or more pairs of predictor variables having interactions based on their respective measures of spatial randomness.

9. The system of claim 8, wherein the first coordinate value is an x-coordinate value, the second coordinate value is a y-coordinate value, and the third coordinate value is a z-coordinate value.

10. The system of claim 8, wherein identifying the one or more pairs of predictor variables having interactions is based on their respective measures of spatial randomness being greater than a threshold measure of spatial randomness.

11. The system of claim 8, wherein the instructions further cause the one or more processors to:
generate interaction functions associated with the respective one or more pairs of predictor variables having interactions.

12. The system of claim 11, wherein the interaction functions associated with the respective one or more pairs of predictor variables having interactions are generated based on relationships between the first predictor variable and second predictor variable of the respective one or more predictor variable pairs.

13. The system of claim 11, wherein generating the interaction functions associated with the respective one or more pairs of predictor variables having interactions includes determining interaction patterns associated with the respective one or more pairs of predictor variables having interactions.

14. The system of claim 13, wherein the interaction patterns include one or more of additive interaction patterns, antagonistic interaction patterns, synergistic interaction patterns, and atypical interaction patterns.

15. A non-transitory computer-readable medium storing instructions for detecting interactions between predictor variables in a statistical model that, when executed by one or more processors, cause the one or more processors to:
obtain a dataset including (i) first predictor variable values, (ii) second predictor variable values, and (iii) dependent variable values associated with each pair of a first predictor variable value and a second predictor variable value;
generate a three-dimensional graph based on the dataset, wherein each point of the three-dimensional graph includes a first coordinate value associated with a first predictor variable, a second coordinate value associated with a second predictor variable, and a third coordinate value associated with a dependent variable outcome; and
analyze the three-dimensional graph to determine a measure of spatial randomness associated with the three-dimensional graph; and
identify one or more pairs of predictor variables having interactions based on their respective measures of spatial randomness.

16. The non-transitory computer-readable medium of claim 15, wherein the first coordinate value is an x-coordinate value, the second coordinate value is a y-coordinate value, and the third coordinate value is a z-coordinate value.

17. The non-transitory computer-readable medium of claim 15, wherein identifying the one or more pairs of predictor variables having interactions is based on their respective measures of spatial randomness being greater than a threshold measure of spatial randomness.

18. The non-transitory computer-readable medium of claim 15, wherein the instructions further cause the one or more processors to:
generate interaction functions associated with the respective one or more pairs of predictor variables having interactions.

19. The non-transitory computer-readable medium of claim 18, wherein the interaction functions associated with the respective one or more pairs of predictor variables having interactions are generated based on relationships between the first predictor variable and second predictor variable of the respective one or more predictor variable pairs.

20. The non-transitory computer-readable medium of claim 18, wherein generating the interaction functions associated with the respective one or more pairs of predictor variables having interactions includes determining interaction patterns associated with the respective one or more pairs of predictor variables having interactions.
